(19) United States
(12) Patent Application Publication
(10) Pub. No.: US 2007/0210716 A1
(43) Pub. Date: Sep. 13, 2007

(54) Surface light source device

(75) Inventors: Kyeong Taek Jung, Suwon-si (KR); Hyung Bin Youn, Suwon-si (KR); Hae Soo Ha, Suwon-si (KR)

Correspondence Address: BEYER WEAVER LLP, P.O. BOX 70250, OAKLAND, CA, 94612-0250, US

(73) Assignee: SAMSUNG CORNING CO., LTD.

(21) Appl. No.: 11/715,220

(22) Filed: Mar. 6, 2007

(30) Foreign Application Priority Data
Mar. 9, 2006 (KR) 10-2006-0022042

(51) Int. Cl. H01J 61/12; H01J 17/20; H01J 61/16

(52) U.S. Cl. 313/637; 313/643

(57) ABSTRACT

There is provided a surface light source device containing 50 ppm or less of water, 50 ppm or less of nitrogen, 30 ppm or less of oxygen, 20 ppm or less of carbon monoxide, and 20 ppm or less of carbon dioxide as impurities in its discharge space. Accordingly, the surface light source device with the impurity standards has improved brightness.

### CROSS-REFERENCE TO RELATED APPLICATION

This application claims the benefit of Korean Patent Application No. 2006-0022042, filed on Mar. 9, 2006, the disclosure of which is hereby incorporated herein by reference in its entirety.

### BACKGROUND OF THE INVENTION

1. Technical Field

The present invention relates to a surface light source device, and more particularly, to standards of impurities contained in a surface light source device of emitting a light in the form of a surface.

2. Discussion of Related Art

In general, liquid crystal (LC) has an electrical characteristic and an optical characteristic. Arrangement of the LC is changed according to a direction of an electric field by the electrical characteristic, and light transmittance of the LC is changed according to the arrangement by the optical characteristic.

A liquid crystal display (LCD) device displays an image, using the electrical characteristic and the optical characteristic of liquid crystal. Since the LCD device is very small in size and light in weight, compared to a cathode-ray tube (CRT) device, it is widely used for portable computers, communication products, liquid crystal television (LCTV) receivers, aerospace industry, and the like.

The LCD device needs a liquid crystal controlling part for controlling the LC, and a light supplying part for supplying a light to the LC.

The liquid crystal controlling part includes a plurality of pixel electrodes disposed on a first substrate, a single common electrode disposed on a second substrate, and liquid crystal interposed between the pixel electrodes and the common electrode. A number of pixel electrodes are used for the resolution of the LCD device, and the single common electrode is placed in opposite to the pixel electrodes. Each pixel electrode is connected to a thin film transistor (TFT) so that each different pixel voltage is applied to the pixel electrode. An equal level of a reference voltage is applied to the common electrode. The pixel electrodes and the common electrode are made of a transparent conductive material.

The light supplying part supplies a light to the LC of the liquid crystal controlling part. The light passes through the pixel electrodes, the LC and the common electrode sequentially. The display quality of an image passing through the LC drastically depends on brightness and brightness uniformity of the light supplying part. Generally, as the brightness and brightness uniformity are high, the display quality is improved.

In a conventional LCD device, the light supplying part generally uses a cold cathode fluorescent lamp (CCFL) in a bar shape or a light emitting diode (LED) in a dot shape. The CCFL has high brightness and long life and generates a small amount of heat, compared to an incandescent lamp. The LED has high brightness. However, in the conventional CCFL or LED, the brightness uniformity is weak.

Therefore, to increase the brightness uniformity, the light supplying part, which uses the CCFL or LED as a light source, needs optical members, such as a light guide panel (LGP), a diffusion member and a prism sheet. Consequently, the LCD device using the CCFL or LED becomes large in size and heavy in weight due to the optical members.

To solve the aforementioned problems, a surface light source device in a flat panel shape has been suggested. Conventional surface light source devices are divided into a surface light source device in which a plurality of discharge spaces are formed by independent partitions (hereinafter, referred to as ‘independent partition type surface light source device’) and a surface light source device in which a plurality of discharge spaces are formed by integrated partitions integrally formed on a corrugated substrate (hereinafter, referred to as ‘integrated partition type surface light source device’).

The conventional independent partition type surface light source device includes a first substrate, a second substrate positioned above the first substrate, and a sealing member, positioned between the edges of the first and second substrates, for defining an inner surface. Independent partitions are positioned in the inner space, thereby dividing the inner space into a plurality of discharge spaces into which a discharge gas including a mercury gas is injected. A fluorescent layer is formed on the inner surfaces of the first and second substrates. An electrode for applying a voltage to the discharge gas is formed, along both side edges of the outer surfaces of the first and second substrates.

The conventional integrated partition type surface light source device includes a first substrate and a second substrate positioned on the first substrate. The second substrate is corrugated to form a plurality of integrated partitions. The partitions contact with the first substrate, thereby forming a plurality of discharge spaces into which a discharge gas is injected. An edge of the second substrate is bonded to the first substrate by frit for sealing. A fluorescent layer is formed on the inner surfaces of the first and second substrates. An electrode for applying a voltage to the discharge gas is formed on the outer edge of the first and second substrates.

Pretty much of power consumed in the LCD device is consumed in a back light unit. Thus, for reducing power consumption, it is absolutely necessary to improve the efficiency of a surface light source device. To reduce the power consumption, many attempts have been directed towards increasing brightness of a surface light source device, enhancing the efficiency of brightness to input power and developing an inverter to improve brightness by optimizing the drive frequency of the surface light source device.

Here, the present invention presents standards of a surface light source device which improves the discharge efficiency as one of the results of research.

### SUMMARY OF THE INVENTION

Therefore, the present invention is directed to provide a surface light source device which improves the efficiency of discharge.

In accordance with an aspect of the present invention, the present invention provides a surface light source device containing 50 ppm or less of water, 50 ppm or less of nitrogen, 30 ppm or less of oxygen, 20 ppm or less of carbon monoxide, and 20 ppm or less of carbon dioxide as impurities in its discharge space.

In accordance with the present invention having the aforementioned constitution, since 50 ppm or less of water, 50 ppm or less of nitrogen, 30 ppm or less of oxygen, 20 ppm or less of carbon monoxide, and 20 ppm or less of carbon dioxide are contained as the impurities in the discharge space, the surface light source device with the above-described impurity standards has improved brightness.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating an independent partition type surface light source device; and

FIG. 2 is a perspective view illustrating an integrated partition type surface light source device.

### DETAILED DESCRIPTION OF THE INVENTION

The present invention will now be described more fully hereinafter with reference to the accompanying drawings, in which preferred embodiments of the invention are shown.

Impurities contained in a surface light source device include water, nitrogen, oxygen, carbon monoxide and carbon dioxide. Specifically, in the present invention, water is contained in the amount of 50 ppm or less, nitrogen is contained in the amount of 50 ppm or less, oxygen is contained in the amount of 30 ppm or less, carbon monoxide is contained in the amount of 20 ppm or less, and carbon dioxide is contained in the amount of 20 ppm or less.

In the surface light source device having the above-described impurity standards, the amounts of the impurities are optimally controlled and thus the impurities less affect a discharge gas. Therefore, the surface light source device has improved brightness.

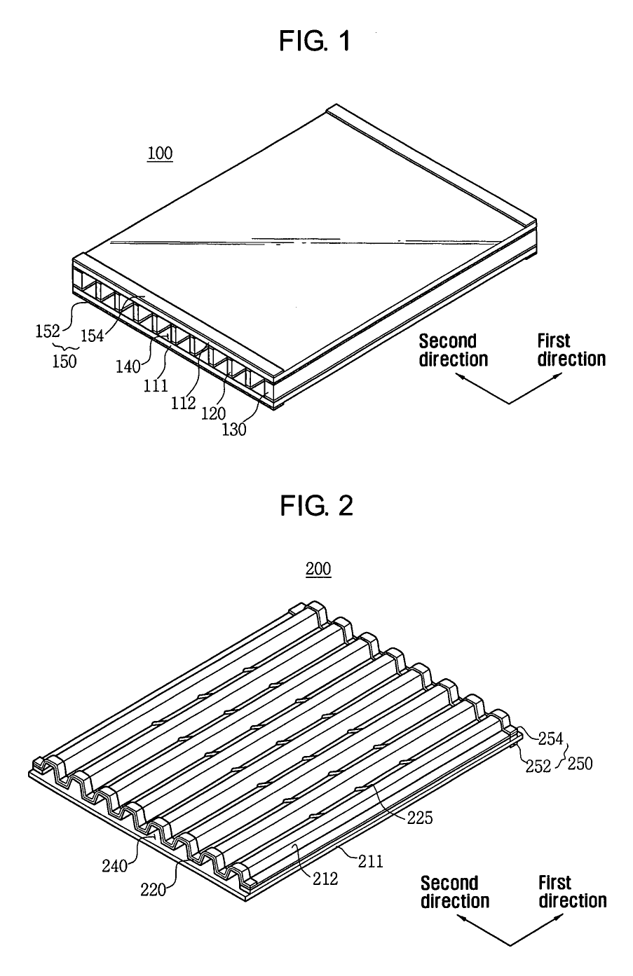

As described above, the surface light source devices having the above-described impurity standards can be classified into an independent partition type surface light source device illustrated in FIG. 1 and an integrated partition type surface light source device illustrated in FIG. 2.

The independent partition type surface light source device and the integrated partition type surface light source device, which have the impurity standards, will be described below.

FIG. 1 is a perspective view illustrating an independent partition type surface light source device 100.

Referring to FIG. 1, the independent partition type surface light source device 100 comprises a light source body and an electrode 150. The light source body has a plurality of discharge spaces into which a discharge gas is injected. The electrode 150 applies a voltage to the discharge gas.

The light source body comprises a first substrate 111, a second substrate 112 disposed on the first substrate 111, a sealing member 130 disposed between the edges of the first and second substrates 111 and 112, for defining an internal space, and a plurality of partitions 120 for partitioning the internal space into a plurality of discharge spaces 140.

The first and second substrates 111 and 112 are made of a glass material which allows a visible light to pass but blocks an ultraviolet light. The second substrate 112 is a light emitting surface from which the light generated in the discharge spaces 140 is emitted.

The partitions 120 are arranged in parallel in the internal space, along a first direction, thereby partitioning the internal space into the plurality of discharge spaces 140 in a stripe shape. A bottom surface of the partitions 120 is in contact with the first substrate 111, and a top surface of the partitions 120 is in contact with the second substrate 112. To inject the discharge gas in each discharge space 140, the partitions 120 may be arranged in a serpentine structure or a passage hole (not shown) may be formed in the partitions 120.

The electrode 150 includes a first electrode 152 formed at the bottom surface of the first substrate 111 and a second electrode 154 formed at the top surface of the second substrate 112. Specifically, the first and second electrodes 152 and 154 are positioned at both edges of the first and second substrates 111 and 112, along a second direction which is substantially at right angles to the first direction. The electrode 150 may be formed using a conductive tape or conductive paste.

A reflecting layer (not shown) is formed on the top surface of the first substrate 111. The reflecting layer allows a light towards the first substrate 111, among the light generated in the discharge spaces, to be reflected to the second substrate 112.

A first fluorescent layer (not shown) is formed on the surface of the reflecting layer, and the first fluorescent layer is excited by the ultraviolet light generated from the discharge gas when a voltage is applied to the discharge gas. A second fluorescent layer (not shown) having the same function as the first fluorescent layer is formed on the bottom surface of the second substrate 112.

FIG. 2 is a perspective view illustrating an integrated partition type surface light source device 200.

Referring to FIG. 2, the integrated partition type surface light source device 200 comprises a light source body and an electrode 250. The light source body has an internal space to which a discharge gas is injected. The electrode 250 applies a voltage to the discharge gas.

The light source body comprises a first substrate 211, and a second substrate 212 disposed on the first substrate 211 and having partitions 220 which are integrally formed on the second substrate 212. The partitions 220 are arranged, along a first direction. The partitions 220 are in contact with the first substrate 211, forming a plurality of discharge spaces 240 in an approximately arch shape. To inject the discharge gas into each discharge space 240, the partitions 220 may be arranged in a serpentine structure or a passage hole 225 may be formed through the partitions 220. Specifically, the passage hole 225 may be formed through the partitions 220 in an oblique line or in an S-shape line. The partitions 220 according to an embodiment of the present invention have an about 1 to 5 mm in width.

The electrode 250 is arranged, along both edges of a light source body 210 in a second direction which is substantially at right angles to the first direction. The electrode 250 includes a first electrode 252 formed at the bottom surface of the first substrate 211 and a second electrode 254 formed at the top surface of the second substrate 212.

A reflecting layer (not shown) is formed on the top surface of the first substrate 211. A first fluorescent layer (not shown) is formed on the surface of the reflecting layer. A second fluorescent layer (not shown) is formed on the bottom surface of the second substrate 212.

A method for manufacturing the integrated partition type surface light source device with the above-described structure will be described. The second substrate 212 is formed such that the partitions are integrally formed on the second substrate 212. The second fluorescent layer is formed on the bottom surface of the second substrate 212. Subsequently, the second substrate 212 is fired. Meanwhile, the reflecting layer is formed on the first substrate 211 and then dried. The first fluorescent layer is formed on the reflecting layer and then dried. Subsequently, the first substrate 211 is fired.

The first and second substrates 211 and 212 are bonded to each other, thereby completing the light source body. The discharge spaces are exhausted to a vacuum with the light source body heated, thereby removing impurities in the discharge spaces of the light source body. Subsequently, a mercury gas is injected into the discharge spaces of the light source body, by using a mercury getter. The electrodes are formed on the outer surfaces of the first and second substrates 211 and 212.

Here, after each of the above-described firing processes, the reflecting layer and the fluorescent layers are exposed to the air. The exposed reflecting layer and the fluorescent layers absorb a great amount of water and nitrogen included in the air. The water absorbed to the reflecting layer and the fluorescent layers are dissolved into hydrogen and oxygen during a discharge operation of the surface light source device.

Hydrogen does rotational vibration in the discharge spaces, thereby decreasing average energy of a mercury electron. Accordingly, the light emitting efficiency of the surface light source device deteriorates due to the decrease in the average energy of the mercury electron.

Oxygen and nitrogen are chemically combined with mercury, thereby forming mercuric oxide and mercuric nitride. Since the mercuric oxide and the mercuric nitride are unable to cause discharge, an amount of mercury in the discharge spaces as good as decreases.

As described above, the impurities, such as water, nitrogen, carbon monoxide, carbon dioxide, and the like, which are contained in the discharge spaces have a great influence on the discharge efficiency of the surface light source device.

Therefore, the present invention controls the impurity content on the above-described technical ground, thereby improving the discharge efficiency of the surface light source device.

Manufacture of Surface Light Source Device

### EXPERIMENTAL EXAMPLE 1

A light source body for an integrated partition type surface light source device is formed. The light source body is fired at the temperature of 550° C. While the light source body is heated at the temperature of 400° C. an exhaust process is performed. A mercury gas is supplied into the light source body. Finally, an electrode is formed on the light source body, thereby manufacturing the integrated partition type surface light source device.

### EXPERIMENTAL EXAMPLE 2

A light source body for an integrated partition type surface light source device is formed. The light source body is fired at the temperature of 500° C. The light source body is preliminarily heated by using a near infrared ray. Then, while the light source body is heated at the temperature of 400° C., an exhaust process is performed. A mercury gas is supplied into the light source body. Finally, an electrode is formed on the light source body, thereby manufacturing the integrated partition type surface light source device.

### EXPERIMENTAL EXAMPLE 3

A light source body for an integrated partition type surface light source device is formed. The light source body is fired at the temperature of 500° C. While the light source body is heated at the temperature of 450° C., an exhaust process is performed. A mercury gas is supplied into the light source body. Finally, an electrode is formed on the light source body, thereby manufacturing the integrated partition type surface light source device.

### EXPERIMENTAL EXAMPLE 4

A light source body for an integrated partition type surface light source device is formed. The light source body is fired at the temperature of 550° C. The light source body is preliminarily heated by using a near infrared ray. Then, while the light source body is heated at the temperature of 450° C., an exhaust process is performed. A mercury gas is supplied into the light source body. Finally, an electrode is formed on the light source body, thereby manufacturing the integrated partition type surface light source device.

### COMPARATIVE EXAMPLE 1

A light source body for an integrated partition type surface light source device is formed. The light source body is fired at the temperature of 500° C. While the light source body is fired at the temperature of 400° C., an exhaust process is performed. A mercury gas is supplied into the light source body. Finally, an electrode is formed on the light source body, thereby manufacturing the integrated partition type surface light source device.

### COMPARATIVE EXAMPLE 2

A light source body for an integrated partition type surface light source device is formed. The light source body is formed by fired the light source body at the temperature of 500° C. 5 grams of water is added into the light source body. Subsequently, while the light source body is heated at the temperature of 400° C., an exhaust process is performed. A mercury gas is supplied into the light source body. Finally, an electrode is formed on the light source body, thereby manufacturing the integrated partition type surface light source device.

Measurement of Amount of Water in Surface Light Source Device

Below, a Table shows results of measuring an amount of water which is contained in each of the surface light source devices according to Experimental Examples 1 through 4 and Comparative Examples 1 and 2.

TABLE

| | Experimental | Experimental | Experimental | Experimental | Comparative | Comparative |
|---|---|---|---|---|---|---|
| | Example 1 | Example 2 | Example 3 | Example 4 | Example 1 | Example 2 |
| Amount | 50 or less | 50 or less | 50 or less | 30 or less | 200 or more | 1,000 or |
| of | | | | | | more |
| water | | | | | | |
| (ppm) | | | | | | |
| Image | 130% | 150% | 200% | 300% | 100% | No lighting |
| quality/ | | | | | | |
| life time | | | | | | |

As indicated in the above Table, 50 ppm or less of water is detected in the surface light source device of Experimental Example 1, in which the surface light source device is manufactured by performing the firing process at the temperature of 550° C. 50 ppm or less of water is detected in the surface light source device of Experimental Example 2, in which the surface light source device is manufactured by additionally performing the process of preliminarily heating the light source body. Similarly, 50 ppm or less of water is detected in the surface light source device of Experimental Example 3, in which the surface light source device is manufactured by performing the exhaust process at the temperature of 450° C. Especially, 30 ppm or less of water is detected in the surface light source device of Experimental Example 4, in which the surface light source device is manufactured by performing all of the above processes.

However, 200 ppm or more of water and 1,000 ppm or more of water are detected in the surface light source devices of Comparative Examples 1 and 2, respectively.

The above results of detecting an amount of water confirm that the amount of water is significantly decreased in the surface light source devices manufactured by the process according to the present invention. Especially, only 30 ppm or less of water is detected in the surface light source device manufactured by performing all of the above-described three processes. Therefore, in order to decrease the impurity content, it is most desirable to manufacture a surface light source device by performing all of the three processes.

A typical surface light source device contains 200 ppm or more of water, 100 ppm or more of nitrogen, 50 ppm or more of oxygen, 50 ppm or more of carbon dioxide, 50 ppm or more of carbon monoxide, and its discharge efficiency is bad.

On the contrary, it is confirmed from results of tests that the surface light source device with the low impurity content has high discharge efficiency. Especially, it is preferable that the surface light source device contains 50 ppm or less of water, 50 ppm or less of nitrogen, 30 ppm or less of oxygen, 20 ppm or less of carbon monoxide, and 20 ppm or less of carbon dioxide as the impurities.

As described above, in the surface light source device in accordance with the present invention, the impurities include 50 ppm or less of water, 50 ppm or less of nitrogen, 30 ppm or less of oxygen, 20 ppm or less of carbon monoxide, and 20 ppm or less of carbon dioxide. Consequently, the influence of the impurities on the discharge gas is minimized, and thus the surface light source device can have improved brightness.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A surface light source device containing 50 ppm or less of water as an impurity in its discharge space.

2. The surface light source device of claim 1, wherein 50 ppm or less of nitrogen is contained as an impurity in the discharge space.

3. The surface light source device of claim 1, wherein 30 ppm or less of oxygen is contained as an impurity in the discharge space.

4. The surface light source device of claim 1, wherein 20 ppm or less of carbon monoxide is contained as an impurity in the discharge space.

5. The surface light source device of claim 1, wherein 20 ppm or less of carbon dioxide is contained as an impurity in the discharge space.

6. The surface light source device containing 50 ppm or less of water, 50 ppm or less of nitrogen, 30 ppm or less of oxygen, 20 ppm or less of carbon monoxide, and 20 ppm or less of carbon dioxide as impurities in its discharge space.
